(19) United States
(12) Patent Application Publication
(10) Pub. No.: US 2025/0047389 A1
(43) Pub. Date: Feb. 6, 2025

(54) OPTICAL TRANSMISSION DEVICE AND TRANSMISSION OPTICAL POWER CONTROL METHOD

(71) Applicant: Fujitsu Limited, Kawasaki-shi (JP)

(72) Inventors: ATSUSHI KODAMA, Kawasaki (JP); Tatsuya TSUZUKI, Kawasaki (JP)

(73) Assignee: Fujitsu Limited, Kawasaki-shi (JP)

(21) Appl. No.: 18/767,425

(22) Filed: Jul. 9, 2024

(30) Foreign Application Priority Data
Jul. 31, 2023 (JP) 2023-125143

(51) Int. Cl. H04B 10/564

(52) U.S. Cl. CPC H04B 10/564

(57) ABSTRACT

An optical transmission device includes an optical transmission amplifier for each band configured to optically amplify signal light of the band of a plurality of different wavelength bands, output level adjuster arranged at a post-stage of the optical transmission amplifier for each band, and configured to adjust an output of the optical transmission amplifier for each band and output the adjusted output to the transmission path, a memory, and a processor coupled to the memory and configured to make the output level adjuster for the each band to reduce a difference in a generalized signal to noise ratio (GSNR) between the bands.

### CROSS-REFERENCE TO RELATED APPLICATION

This application is based upon and claims the benefit of priority of the prior Japanese Patent Application No. 2023-125143, filed on Jul. 31, 2023, the entire contents of which are incorporated herein by reference.

### FIELD

The embodiment discussed herein is related to an optical transmission device and a transmission optical power control method.

### BACKGROUND

Wavelength division multiplexing (WDM) has been put into practical use to provide large-capacity optical communication. By the WDM, signals are transmitted using a plurality of wavelength channels, and a large number of wavelength channels are multiplexed, thereby implementing the large-capacity optical communication.

Transmission characteristics of a WDM signal depend on a wavelength. In order to maximize the transmission characteristics and transmit transmission light far away, it is needed to minimize noise caused by the transmission and to appropriately set transmission path input power on a reception side. Thus, on a transmission side, it is needed to determine the transmission path input power so as to minimize a relative noise amount (maximize a generalized signal to noise ratio (SNR) (GSNR)). The relative noise amount depends on the transmission path input power, and includes amplified spontaneous emission (ASE) noise and nonlinear noise.

Furthermore, in recent years, a bandwidth has been expanded in a WDM transmission system, and a multi-band WDM transmission system that transmits signals by simultaneously using a C-band and an L-band has been proposed.

As prior art related to transmission optical power control of an optical transmission device with an expanded bandwidth, each of the following Patent Documents is disclosed. For example, there is a technology of attenuating and controlling a gain tilt amount of a transmission amplifier and a transmission amplifier output in response to a change in the number of wavelengths accommodated in multiple bands to stabilize input power of a reception amplifier and performing stimulated Raman scattering (SRS) compensation. Furthermore, there is a technology of making a GSNR equalized by controlling a wavelength selective switch (WSS), a gain tilt amount of an optical transmission amplifier of each band, and the like on a transmission side of C+L transmission. Furthermore, there is a technology of providing a variable optical attenuator (VOA) in each channel of an optical relay station, and adjusting a level between the channels to activate the optical relay station. Furthermore, there is a technology of monitoring a signal-to-noise (SN) ratio for each channel and adjusting optical power by a variable optical attenuator. Furthermore, there is a technology of improving an optical signal to-noise ratio (OSNR) by adjusting power for each wavelength by controlling an attenuation amount of a WSS and a gain gradient of an optical transmission amplifier.

Japanese Laid-open Patent Publication No. 2019-186735, U.S. Patent Application Publication No. 2022/0368448, International Publication Pamphlet No. WO 2002/019572, U.S. Pat. No. 7,020,092, and Japanese Laid-open Patent Publication No. 2018-182667 are disclosed as related art.

### SUMMARY

According to an aspect of the embodiments, an optical transmission device includes an optical transmission amplifier for each band configured to optically amplify signal light of the band of a plurality of different wavelength bands, output level adjuster arranged at a post-stage of the optical transmission amplifier for each band, and configured to adjust an output of the optical transmission amplifier for each band and output the adjusted output to the transmission path, a memory, and a processor coupled to the memory and configured to make the output level adjuster for the each band to reduce a difference in a generalized signal to noise ratio (GSNR) between the bands.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an optical transmission system including an optical transmission device according to an embodiment;

FIG. 2 is a table for describing optimization of transmission path input power;

FIG. 3 is a diagram illustrating a configuration example of an optical transmission system including an optical transmission device according to prior art;

FIG. 4 is an explanatory diagram of wavelength selective switch (WSS) attenuation amount control and amplifier gain tilt amount control in the prior art;

FIG. 5A is a level diagram in a case where generalized signal to noise ratio (GSNR) equalization is not performed in the prior art;

FIG. 5B is a diagram illustrating a state where a GSNR difference occurs for each band due to a noise figure (NF) difference in a case where the GSNR equalization is not performed;

FIG. 6 is a diagram illustrating the GSNR difference for each band in a case where the GSNR equalization is not performed;

FIG. 7A is a level diagram in a case where the GSNR equalization is performed in the prior art;

FIG. 7B is a diagram illustrating the GSNR for each band at the time of the GSNR equalization according to the prior art;

FIG. 8 is a diagram illustrating the GSNR for each band at the time of the GSNR equalization according to the prior art;

FIG. 9 is an explanatory diagram of attenuation amount control and amplifier gain tilt amount control according to the embodiment;

FIG. 10A is a level diagram in a case where GSNR equalization is performed according to the embodiment;

FIG. 10B is a diagram illustrating a GSNR for each band at the time of the GSNR equalization according to the embodiment;

FIG. 11 is a diagram illustrating the GSNR for each band at the time of the GSNR equalization according to the embodiment;

FIG. 12A is an explanatory diagram of the transmission path input power in the embodiment;

FIG. 12B is an explanatory diagram of a variable optical attenuator (VOA) control amount in the embodiment;

FIG. 13 is a diagram illustrating a hardware configuration example of a control unit of the optical transmission device;

FIG. 14 is a flowchart illustrating a control processing example of the control unit (part 1); and

FIG. 15 is a flowchart illustrating the control processing example of the control unit (part 2).

### DESCRIPTION OF EMBODIMENTS

In the prior art, in a case where a configuration is applied in which a WSS attenuation amount is controlled and a gain tilt amount of an optical transmission amplifier is controlled for each band in multi-band transmission in order to make a GSNR of each band (between all channels) of C+L transmission equalized, an attenuation control amount of a WSS increases. Although details will be described later, a noise figure (NF) of the L-band is worse than that of the C-band, and the C-band and the L-band have a GSNR difference. When attenuation amount control of the WSS is performed on the entire C+L bands without considering this difference, for example, a decrease in input optical power to an optical transmission amplifier on the C-band side is caused and an OSNR decreases, so that the transmission characteristics may not be improved.

Hereinafter, an embodiment of an embodiment of techniques to eliminate a GSNR difference between bands in multi-band transmission and improve transmission performance will be described in detail with reference to the drawings.

### Configuration Example of Optical Transmission Device of Embodiment

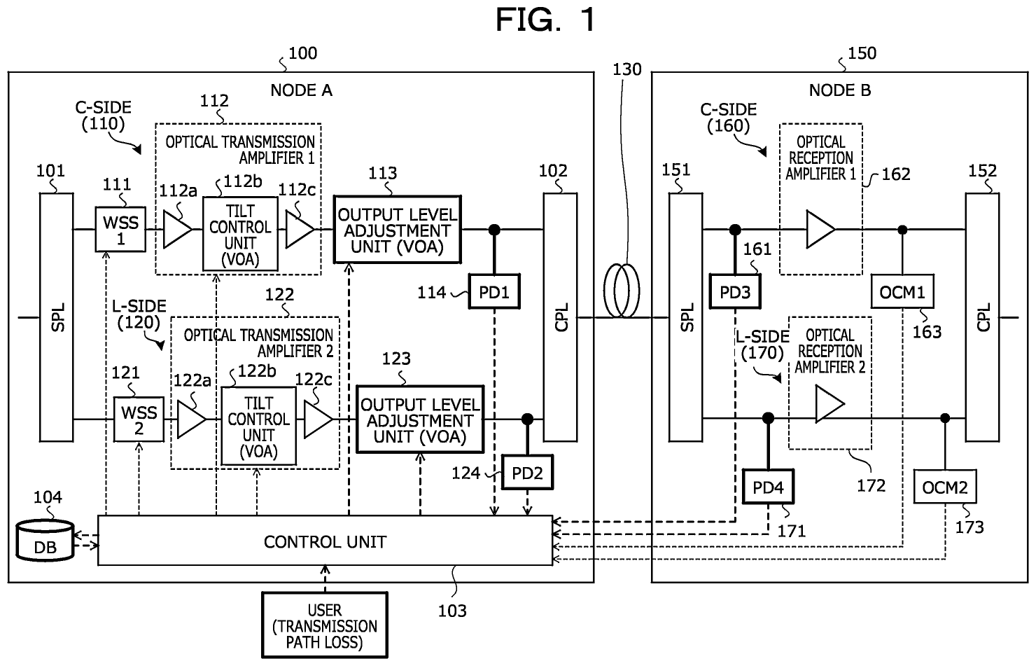

FIG. 1 is a diagram illustrating an optical transmission system including the optical transmission device according to the embodiment. The optical transmission system includes a node A (100) that transmits optical signals in bands of a C-band and an L-band of wavelength division multiplexing (WDM), a node B (150) that receives the optical signals, and a transmission path 130 such as an optical fiber that couples the node A (100) and the node B (150). An optical transmission device 100 of the embodiment mainly corresponds to the node A (100) that transmits optical signals.

In the system example of FIG. 1, a pair of the node A (100) and the node B (150) in one section (one span) is described. Each node may be a relay node having functions of the nodes A and B (100, 150), and in this case, an optical transmission system including a plurality of the relay nodes via the transmission path 130 is constructed.

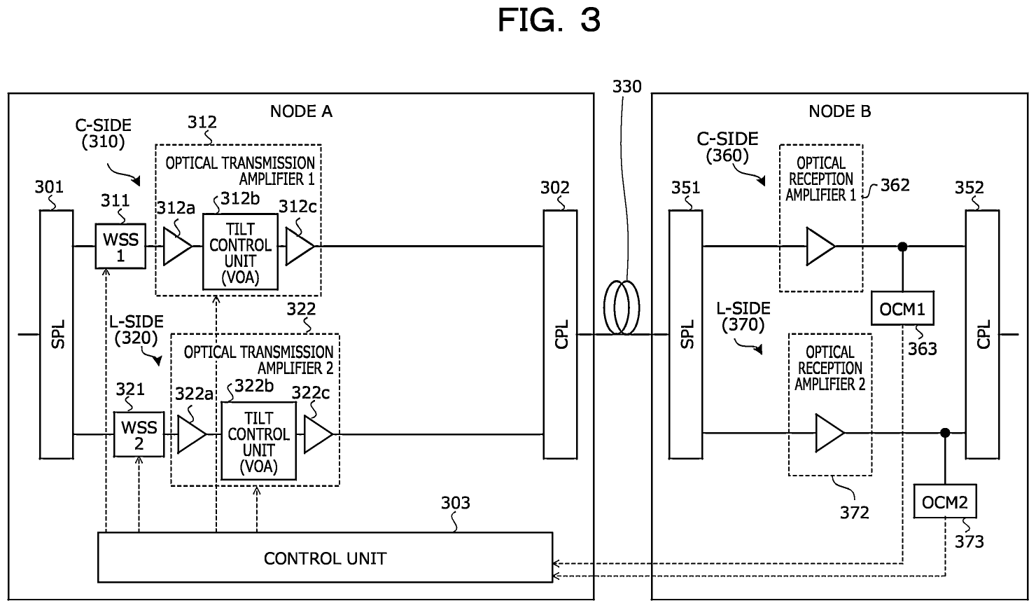

The node A (100) includes an optical demultiplexer (SPL) 101, a C-side transmission unit 110, an L-side transmission unit 120, an optical multiplexer (CPL) 102, a control unit 103, and a storage unit that stores information for control, for example, a database (DB) 104. Note that the respective units (the DB 104, output level adjustment units 113 and 123, PDs 1 to 4 (114, 124, 161, 171), and the like) indicated by bold lines in FIG. 1 indicate components different from (added to) those of a configuration example of prior art (FIG. 3) described later.

The DB 104 holds, for example, an output level of a post-stage amplifier 112c (variable optical attenuator (VOA) 113) inside an optical transmission amplifier of the C-band and an output level of a post-stage amplifier 122c (VOA 123) inside an optical transmission amplifier of the L-band such that generalized signal to noise ratios (GSNRs) of the C-band and the L-band at the time of the maximum number of wavelengths are equalized, and the output levels are referred to by the control unit 103. The time of the maximum number of wavelengths corresponds to the time of data communication of all channels of the C-band and the L-band.

The SPL 101 separates a WDM signal into the C-band and the L-band by wavelength, and outputs the WDM signal separated by wavelength to each of the C-side transmission unit 110 and the L-side transmission unit 120.

The C-side transmission unit 110 includes a wavelength selective switch (WSS) 1 (111), an optical transmission amplifier 1 (112), the output level adjustment unit 113, and the PD 1 (optical power monitor) 114. The WSS 1 (111) adjusts optical power of each wavelength channel of a WDM signal of the C-band based on the control of the control unit 103.

The optical transmission amplifier 1 (112) optically amplifies a WDM signal of the C-band based on the control of the control unit 103. The optical transmission amplifier 1 (112) includes a pre-stage amplifier 112a, a tilt control unit 112b, and the post-stage amplifier 112c. The pre-stage amplifier 112a optically amplifies signal light of the C-band output from the WSS 1 (111).

The tilt control unit 112b is, for example, a variable optical attenuator (VOA), and performs control to adjust an amplifier gain tilt amount (inclination of optical power relative to a wavelength of the C-band) of the pre-stage amplifier 112a based on the control of the control unit 103. The post-stage amplifier 112c optically amplifies signal light of the C-band output from the tilt control unit 112b.

The output level adjustment unit 113 is, for example, a variable optical attenuator (VOA), and adjusts an output level of signal light of the C-band output by the optical transmission amplifier 1 (112) based on the control of the control unit 103. The PD 1 (114) detects optical power of C-band signal light output from the output level adjustment unit 113, and outputs the optical power to the control unit 103.

In the embodiment, based on characteristics that noise figures (NFs) of the optical transmission amplifiers 1 and 2 (112, 122) are different for the respective bands, VOA (attenuation amount) control for the respective bands is performed by the output level adjustment units 113 and 123 at the post-stages of the optical transmission amplifiers 1 and 2 (112, 122).

The CPL 102 optically outputs, to the transmission path 130, WDM signal light (transmission light) obtained by wavelength-multiplexing signal light of the C-band of the C-side transmission unit 110 and signal light of the L-band of the L-side transmission unit 120.

The L-side transmission unit 120 also includes the respective units similar to those of the C-side transmission unit 110. The L-side transmission unit 120 includes a WSS 2 (121), the optical transmission amplifier 2 (122), the output level adjustment unit 123, and the PD 2 124. The WSS 2 (121) adjusts optical power of each wavelength channel of a WDM signal of the L-band based on the control of the control unit 103.

The optical transmission amplifier 2 (122) optically amplifies a WDM signal of the L-band based on the control of the control unit 103. The optical transmission amplifier 2 (122) includes a pre-stage amplifier 122a, a tilt control unit 122b, and the post-stage amplifier 122c. The pre-stage amplifier 122a optically amplifies signal light of the L-band output from the WSS 2 (121). As these optical amplifiers, for example, an erbium-doped fiber amplifier (EDFA) is used.

The tilt control unit 122b is, for example, a variable optical attenuator (VOA), and performs control to adjust an amplifier gain tilt amount (inclination of optical power relative to a wavelength of the L-band) of the pre-stage amplifier 122a based on the control of the control unit 103. The post-stage amplifier 122c optically amplifies signal light of the L-band output from the tilt control unit 122b.

The output level adjustment unit 123 is, for example, a variable optical attenuator (VOA), and adjusts an output level of signal light of the L-band output by the optical transmission amplifier 2 (122) based on the control of the control unit 103. The PD 2 (124) detects optical power of signal light of the L-band output from the output level adjustment unit 123, and outputs the optical power to the control unit 103.

In order to maximize a GSNR of C+L, the control unit 103 performs target power calculation and control on transmission power of each of the C-side transmission unit 110 (the WSS 1 and the optical transmission amplifier 1) and the L-side transmission unit 120 (the WSS 2 and the optical transmission amplifier 2).

The node B (150) that receives signal light includes an optical demultiplexer (SPL) 151, a C-side reception unit 160, an L-side reception unit 170, and an optical multiplexer (CPL) 152.

The SPL 151 separates a WDM signal of C+L transmitted from the node A (100) via the transmission path 130 into the C-band and the L-band by wavelength, and outputs the WDM signal separated by wavelength to each of the C-side reception unit 160 and the L-side reception unit 170.

The C-side reception unit 160 includes the PD 3 (161), an optical reception amplifier 1 (162), and an optical channel monitor (OCM 1) 163. The PD 3 (161) detects optical power of the C-band separated by wavelength by the SPL 151, and outputs the optical power to the control unit 103. The optical reception amplifier 1 (162) optically amplifies signal light of the C-band. The OCM 1 (163) monitors optical power of each channel of the C-band optically amplified by the optical reception amplifier 1 (162), and outputs the optical power to the control unit 103.

The L-side reception unit 170 also includes the respective units similar to those of the C-side reception unit 160. The L-side reception unit 170 includes the PD 4 (171), an optical reception amplifier 2 (172), and an optical channel monitor (OCM 2) 173. The PD 4 (171) detects optical power of the L-band separated by wavelength by the SPL 151, and outputs the optical power to the control unit 103. The optical reception amplifier 2 (172) optically amplifies signal light of the L-band. The OCM 2 (173) monitors optical power of each channel of the L-band optically amplified by the optical reception amplifier 2 (172), and outputs the optical power to the control unit 103.

The optical power detected by the PDs 3 and 4 (161, 171) and the OCMs 1 and 2 (163, 173) of the node B (150) is fed back to the control unit 103 of the node A (100). This feedback is transmitted from the node B (150) to the node A (100) using, for example, an optical supervisory channel (OSC). The OSC may be transmitted using a wavelength band different from a wavelength band of a main signal via another transmission path for transmitting optical signals from the node B (150) to the node A (100).

The optical power of the C-band and the L-band detected by the PDs 1 and 2 (114, 124) in the node A (100) and the feedback from the node B (150) are input to the control unit 103. The feedback input includes the optical power of the C-band and the L-band detected by the PDs 3 and 4 (161, 171) and the optical power of each channel of the C-band and the L-band detected by the OCMs 1 and 2 (163, 173).

The control unit 103 determines transmission path input power of each channel such that GSNRs of optical signals transmitted by the node A (100) are equalized. The transmission path input power corresponds to transmission power of optical signals (transmission light) output to the transmission path 130 by the transmitting node A (100).

The control unit 103 calculates a GSNR of each wavelength channel, and performs, based on the calculated GSNR, optical attenuation control in the WSSs 1 and 2 (111, 121) and amplifier gain tilt amount control by the tilt control units 112b and 122b for each band. The WSS control and the amplifier gain tilt amount control for each band are existing technologies disclosed in U.S. Patent Application Publication No. 2022/0368448 described above.

Additionally, in the optical transmission device 100 of the embodiment, optical attenuation amounts for the respective band are further controlled for the output level adjustment units (VOAs) 113 and 123 such that outputs of the optical transmission amplifiers 112 and 122 (post-stage amplifiers 112c and 122c) of the respective bands become predetermined average output levels.

Thus, for example, the control unit 103 determines the transmission path input power of each band (the C-band and the L-band) based on information regarding a transmission path loss input by a user. Without limitation to this, the control unit 103 may calculate a transmission path loss of the transmission path 130 based on the optical power detected by each of the PDs 1 and 2 (114, 124) and the PDs 3 and 4 (161, 171), and determine the transmission path input power. In a case where the information regarding the transmission path loss is input by the user, the PDs 1 and 2 (114, 124) and the PDs 3 and 4 (161, 171) illustrated in FIG. 1 may be omitted.

The control unit 103 determines average output levels (average power) of the post-stage amplifiers 112c and 122c of the respective bands based on the determined transmission path input power. For example, the control unit 103 calculates the average power for each band by calculating “total power of each band÷the number of wavelengths”. Furthermore, the control unit 103 may calculate the average power from monitor values of the respective channels detected by the OCMs 1 and 2 (163, 173). The control unit 103 controls the optical attenuation amounts for the respective bands for the output level adjustment units (VOAs) 113 and 123 such that the outputs of the post-stage amplifiers 112c and 122c become the average output levels for the respective bands.

For example, the output level of the post-stage amplifier 112c (VOA 113) of the C-band and the output level of the post-stage amplifier 122c (VOA 123) of the L-band such that GSNRs of the C-band and the L-band at the time of the maximum number of wavelengths are equalized are held in the DB 104 in advance. The control unit 103 refers to the DB 104 and controls the output levels for the respective bands by the VOAs 113 and 123. For example, the control unit 103 controls the output of the VOA 113 of the L-band to be higher than the output of the VOA 123 of the C-band.

As described above, in the embodiment, a noise figure (NF) of the L-band is worse than that of the C-band, and the VOAs 113 and 123 are provided for the respective bands to perform output level adjustment in consideration of the difference generated in the GSNR between the C-band and the L-band. In this case, for example, each of the C-band and the L-band has different optimal transmission path input power. As a result, the GSNR of each band may be maximized, and the transmission characteristics of the entire C+L may be improved.

Meanwhile, as various types of information for control held by the DB 104, for example, the transmission path input power for the respective bands with which the GSNRs of the C-band and the L-band are equalized is held. Furthermore, in relation to the transmission path input power for the respective bands, the DB 104 holds information regarding the attenuation amounts of the WSSs 1 and 2 and the amplifier gain tilt amounts of the C-side transmission unit 110 and the L-side transmission unit 120 for making the GSNRs equalized. Furthermore, the DB 104 holds the information regarding the output levels (attenuation amounts) of the VOAs 113 and 123.

Furthermore, the DB 104 holds information regarding a loss (span loss) of the transmission path 130 due to a user input or the like. In addition, the DB 104 includes and holds specification values of characteristics (noise figures (NFs)) of the respective optical amplifiers included in the node A (100) and the node B (150) or characteristic values measured in advance.

For example, the DB 104 includes and holds the NF values of the optical transmission amplifiers 1 and 2 (112, 122) and further the optical reception amplifiers 162 and 172 of the node B. The control unit 103 may calculate the SNR for each band by referring to the DB 104. In addition, in a case where the nodes A and B include Raman amplification units, the DB 104 may hold characteristic values including NFs of Raman amplification.

Each piece of the information held by the DB 104 is referred to by the control unit 103 to control equalization of the GSNRs. The control unit 103 performs attenuation amount control of the WSSs 1 and 2 (111, 121) and amplifier gain tilt amount control of the optical transmission amplifiers 1 and 2 (112, 122). In addition, in the embodiment, the control unit 103 performs VOA control on the VOAs 113 and 123 arranged for the respective bands.

The configuration example illustrated in FIG. 1 is an example, and each of the node A (100) and the node B (150) may configured by including a front Raman amplifier and a rear Raman amplifier, an optical time domain reflectometer (OTDR), and the like.

### Prior Art and Problems Thereof

Here, the prior art and problems thereof will be described. In transmission design, in order to transmit signal light far away and maximize transmission performance, it is needed to minimize noise caused by the transmission and to optimize transmission path input power. The transmission path input power is determined so as to minimize a relative noise amount (=maximize a GSNR).

The relative noise amount (transmission path input power-dependent amount) is indicated by Noise/Signal=1/GSNR=(Pₐₛₑ/P_{sig}+P_{NLI}/P_{sig}). An amplified spontaneous emission (ASE) noise amount of Pₐₛₑ/P_{sig} and a nonlinear noise amount of P_{NLI}/P_{sig} are minimized. ASE noise includes an optical amplifier characteristic (NF) and optical amplifier input power (transmission path input power). Nonlinear noise includes a fiber type (SMF, DSF, or the like) of a transmission path, a fiber loss coefficient, transmission path input power, and the like. The SMF stands for single mode fiber, and the DSF stands for dispersion shifted fiber.

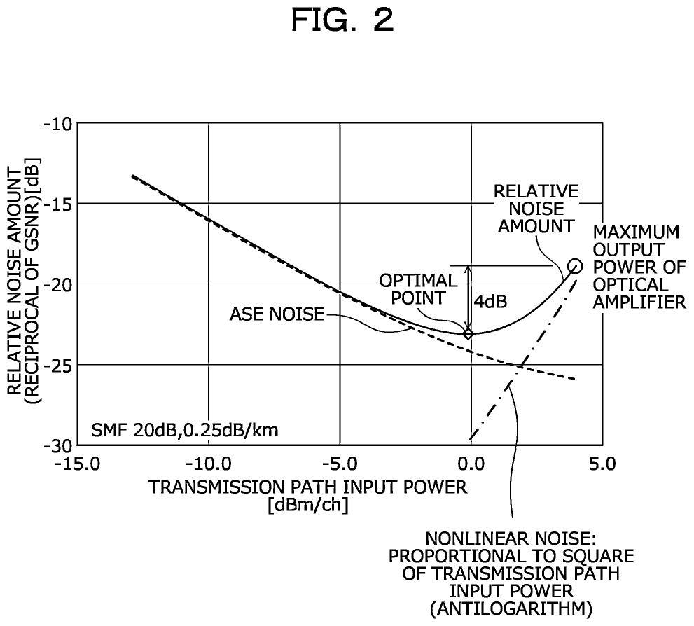

FIG. 2 is a table for describing optimization of the transmission path input power. A characteristic seen at a node on a reception side in a case where a transmission path is the SMF is indicated, and a horizontal axis represents the transmission path input power, and a vertical axis represents the relative noise amount (a reciprocal of the GSNR).

In the following description, the description will be made assuming that power: dBm, total power, and level: dBm/ch, channel average power.

The ASE noise of an amplifier (dotted line) has a characteristic that the higher the transmission path input power, the better an optical signal-to-noise ratio (OSNR). The nonlinear noise (dashed line) has a characteristic proportional to a square of the transmission path input power (antilogarithm). Additionally, the relative noise amount (solid line) has a characteristic of increasing in any case of increase or decrease centered on an optimal point of the transmission path input power.

The smaller the relative noise amount, the better the transmission performance. Thus, in the transmission design, the transmission path input power is set so as to reduce the relative noise amount. In a case where the transmission path input power is not set to the optimal point, a transmission distance decreases by 60% (−4 dB). Note that the optimal point is different between the C-band and the L-band.

FIG. 3 is a diagram illustrating a configuration example of an optical transmission system including an optical transmission device according to the prior art. FIG. 3 corresponds to U.S. Patent Application Publication No. 2022/0368448 described above, and discloses the configuration example in which GSNRs are made equalized in a C+L transmission system.

A node A illustrated in FIG. 3 includes an optical demultiplexer (SPL) 301, a C-side transmission unit 310, an L-side transmission unit 320, an optical multiplexer (CPL) 302, and a control unit 303.

The C-side transmission unit 310 includes a WSS 1 (311) and an optical transmission amplifier 1 (312). The optical transmission amplifier 1 (312) includes a pre-stage amplifier 312a, a tilt control unit (VOA) 312b, and a post-stage amplifier 312c.

The L-side transmission unit 320 includes a WSS 2 (321) and an optical transmission amplifier 2 (322). The optical transmission amplifier 2 (322) includes a pre-stage amplifier 322a, a tilt control unit (VOA) 322b, and a post-stage amplifier 322c.

A node B is coupled to the node A via a transmission path 330, and includes an optical demultiplexer (SPL) 351, a C-side reception unit 360, an L-side reception unit 370, and an optical multiplexer (CPL) 352. The C-side reception unit 360 includes an optical reception amplifier 1 (362) and an OCM 1 (363). The L-side reception unit 370 includes an optical reception amplifier 2 (372) and an OCM 2 (373).

The respective OCMs 1 and 2 (363, 373) detect optical power for each channel of a C-band and an L-band, and outputs the optical power to the control unit 303 of the node A.

The control unit 303 calculates a GSNR of each wavelength channel, and performs, based on the calculated GSNR, optical attenuation control in WSSs 1 and 2 (311, 321) and amplifier gain tilt amount control by the tilt control units 312b and 322b for the respective bands.

In a case where the configuration example of the prior art illustrated in FIG. 3 is compared with that of the embodiment of FIG. 1, the embodiment of FIG. 1 is different from FIG. 3 mainly in that the VOAs 1 and 2 (113, 123) are added.

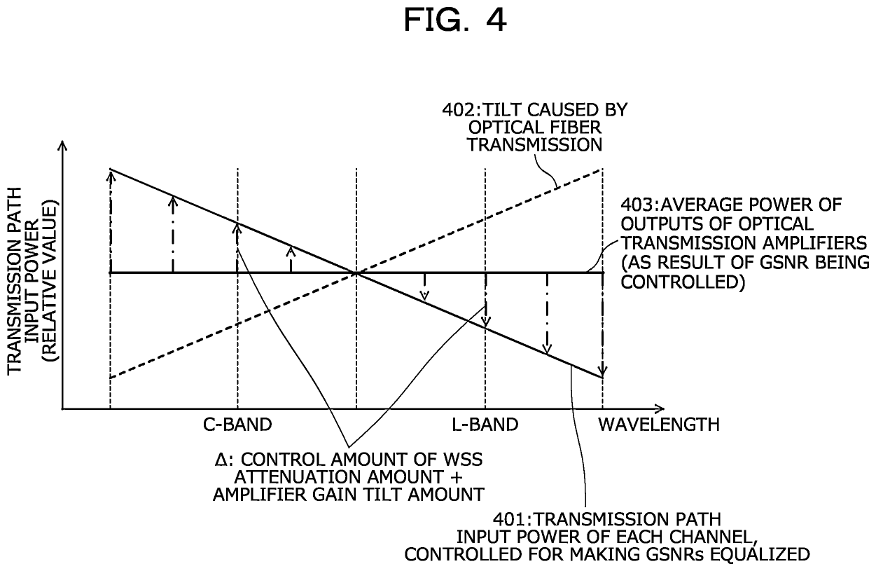

FIG. 4 is an explanatory diagram of WSS attenuation amount control and amplifier gain tilt amount control in the prior art. In the prior art, the optical attenuation control in the WSSs 1 and 2 (311, 321) and the control of amplifier gain tilt amounts of the optical transmission amplifiers 1 and 2 (312, 322) for the respective bands by the tilt control units (VOA) 312b and 322b are performed so that the GSNRs are equalized.

In FIG. 4, a horizontal axis represents a wavelength (C-band, L-band), and a vertical axis represents the transmission path input power (relative value). A reference sign 401 (solid line) in FIG. 4 denotes the transmission path input power (control target value) of each channel for making the GSNRs of C+L equalized. A reference sign 402 (dotted line) in FIG. 4 denotes a tilt caused by optical fiber transmission of the transmission path 330.

A reference sign 403 (bold line) denotes average power of outputs of the optical transmission amplifiers 1 and 2 (312, 322) as a result of the GSNRs being controlled. The control unit 303 performs the optical attenuation amount control by the WSSs 1 and 2 (311, 321) and the amplifier gain tilt amount control by the optical transmission amplifiers 1 and 2 (312, 322). In the example of FIG. 4, regarding a control amount Δ (dashed line) of the WSS attenuation amount+the amplifier gain tilt amount, control is performed to increase output power as the wavelength becomes shorter in the C-band, and control is performed to decrease output power as the wavelength becomes longer in the L-band.

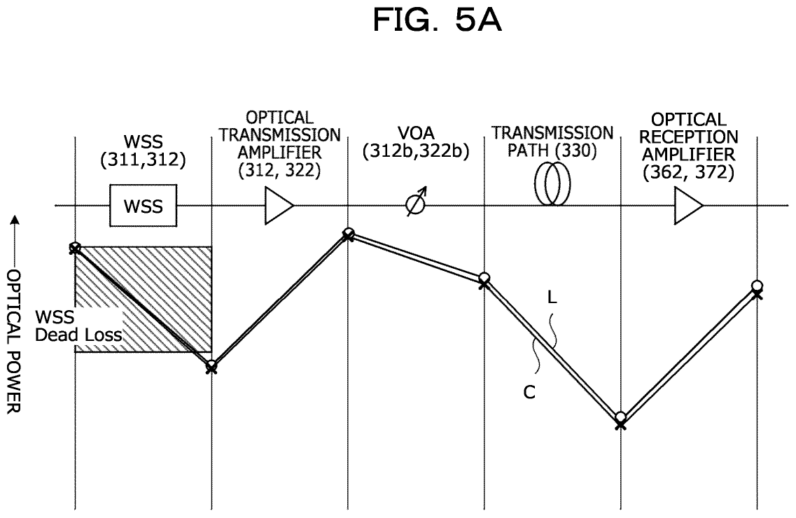

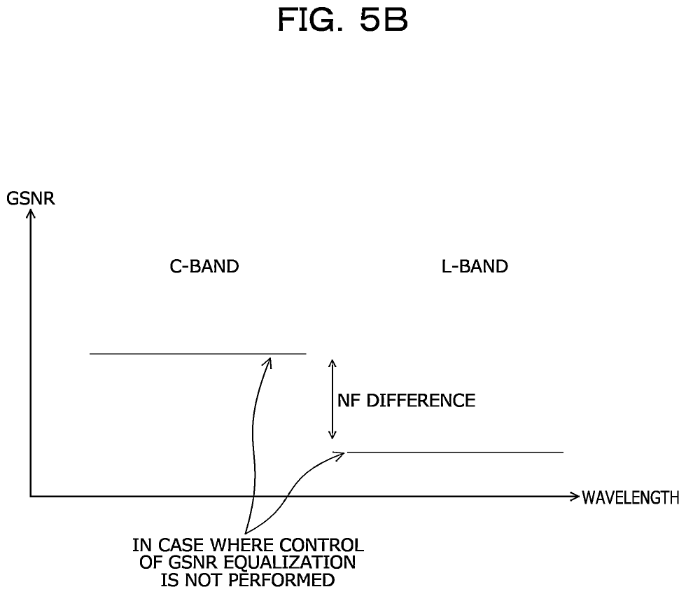

FIG. 5A is a level diagram in a case where GSNR equalization is not performed in the prior art. A horizontal axis represents each of the WSSs 1 and 2 (311, 312), the optical transmission amplifiers 1 and 2 (312, 322), and the VOAs 312b and 322b of the node A, the transmission path 330, and the optical reception amplifiers 1 and 2 (362, 372), and a vertical axis represents optical power.

In the drawing, ◯ indicates average power of the L-band, and x indicates average power of the C-band. As illustrated in FIG. 5A, a change state of the optical power in each unit is such that the optical power is attenuated by the WSSs 1 and 2 (311, 312), then increased by optical amplification by the optical transmission amplifiers 1 and 2 (312, 322), and then attenuated corresponding to the amplifier gain tilt amounts by the VOAs 312b and 322b. In the transmission path 330, attenuation occurs in the optical power due to a transmission path loss, and in the optical reception amplifiers 1 and 2 (362, 372), the optical power is increased by optical amplification. In the case where the GSNR equalization is not performed illustrated in FIG. 5A, the average power of the L-band and the C-band changes at the same level in each unit.

FIG. 5B is a diagram illustrating a state where a difference in the GSNR occurs for each band due to an NF difference in the case where the GSNR equalization is not performed. A horizontal axis represents a wavelength, and a vertical axis represents the GSNR. As illustrated in FIG. 5B, the optical transmission amplifier 2 (322) of the L-band has a worse NF than that of the optical transmission amplifier 1 (312) of the C-band, and a difference in the GSNR (NF difference) occurs between the bands in the case where the control of the GSNR equalization is not performed. In order to eliminate the NF difference, it is needed to reduce a loss of the WSS 2 (312) of the L-band.

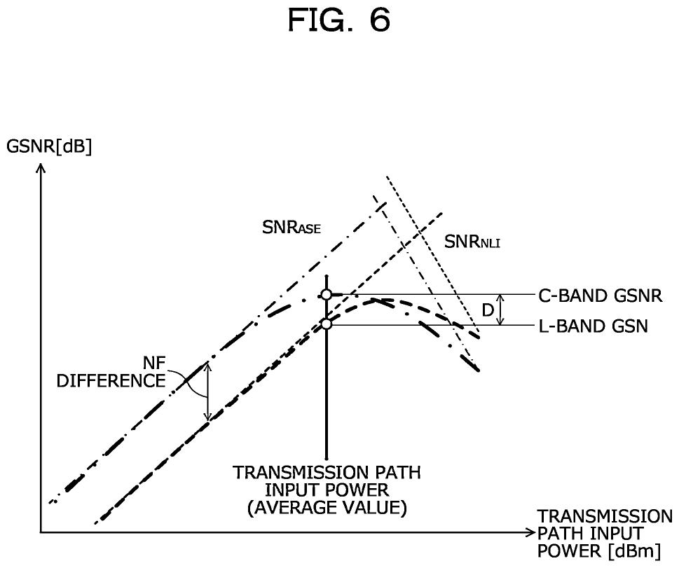

FIG. 6 is a diagram illustrating the GSNR difference for each band in the case where the GSNR equalization is not performed. A horizontal axis represents the transmission path input power, and a vertical axis represents the GSNR of each of the C-band and the L-band corresponding to FIG. 2.

The GSNR is indicated by 1/GSNR=1/SNR_{ASE}+1/SNR_{NLI} . . . (1).

As illustrated in FIG. 6, based on an NF difference between a GSNR characteristic of the C-band (dashed line) and a GSNR characteristic of the L-band (dotted line), a difference D occurs in the GSNR in the transmission path input power (average value) portion.

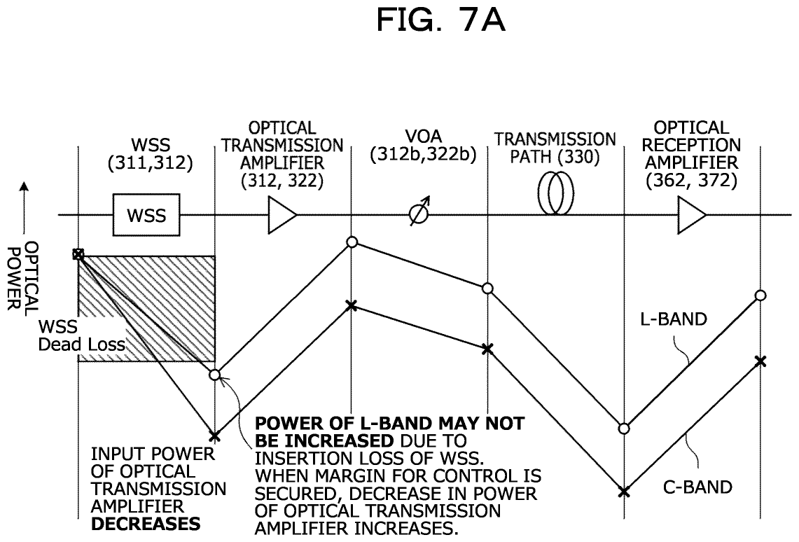

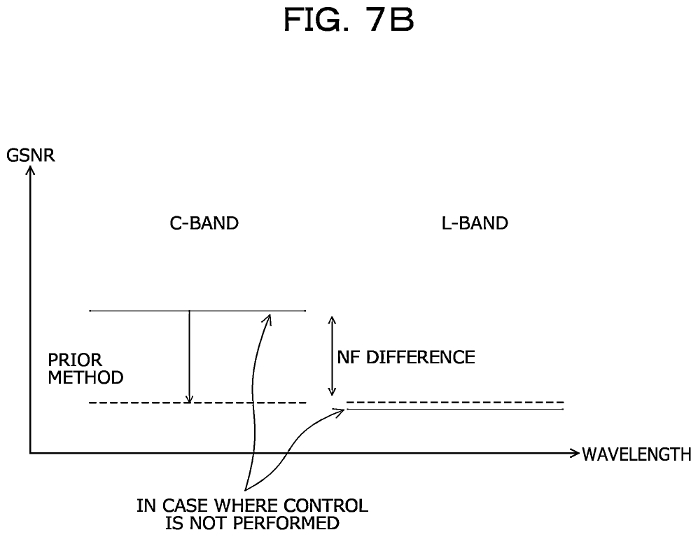

FIG. 7A is a level diagram in a case where the GSNR equalization is performed in the prior art. FIG. 7B is a diagram illustrating the GSNR for each band at the time of the GSNR equalization according to the prior art. As illustrated in FIG. 7B, in order to eliminate the NF difference described above, for example, the GSNR of the C-band is decreased to make the GSNRs of the C-band and the L-band equalized.

In order to obtain an expected level of a transmission path input to the transmission path 330 by the GSNR equalization according to the prior art, when control is performed to lower the optical power at an output unit of the WSS 1 (311) of the C-band as illustrated in FIG. 7A, input power to the optical transmission amplifier 1 (312) decreases.

Here, since the WSSs 1 and 2 (311, 321) have a unique insertion loss (dead loss), the WSS 2 (321) has a constraint that the optical power to be input to the optical transmission amplifier 2 (322) of the L-band may not be increased. When a margin for the attenuation amount control is secured in the WSS 2 (321) of the L-band, a decrease in the power to be input to the optical transmission amplifier 2 (322) increases.

Thus, in the GSNR equalization in the prior art, for the GSNR difference between the C-band and the L-band, the GSNRs are made equalized by degrading the GSNR of the C-band to match the bad GSNR of the L-band.

In the case where the GSNR equalization is performed in the prior art, since the input power to the optical transmission amplifier 1 (312) of the C-band decreases, the OSNR of the C-band decreases, and the GSNR as an absolute value decreases.

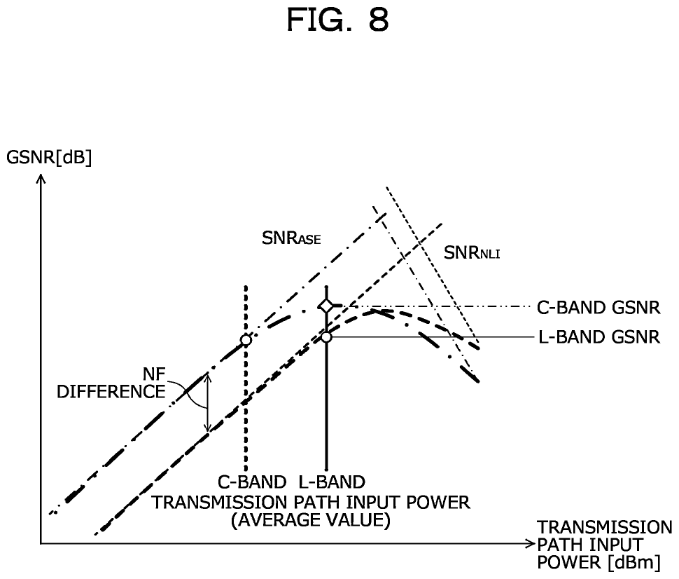

FIG. 8 is a diagram illustrating the GSNR for each band at the time of the GSNR equalization according to the prior art. The GSNR characteristics for the respective bands in the case where the GSNR equalization is performed in the prior art are illustrated in contrast with FIG. 6. As illustrated in FIG. 8, the GSNR difference between the bands due to the NF difference is eliminated by degrading the GSNR of the C-band. However, at the time of the GSNR equalization, the transmission path input power (average value) of the C-band decreases.

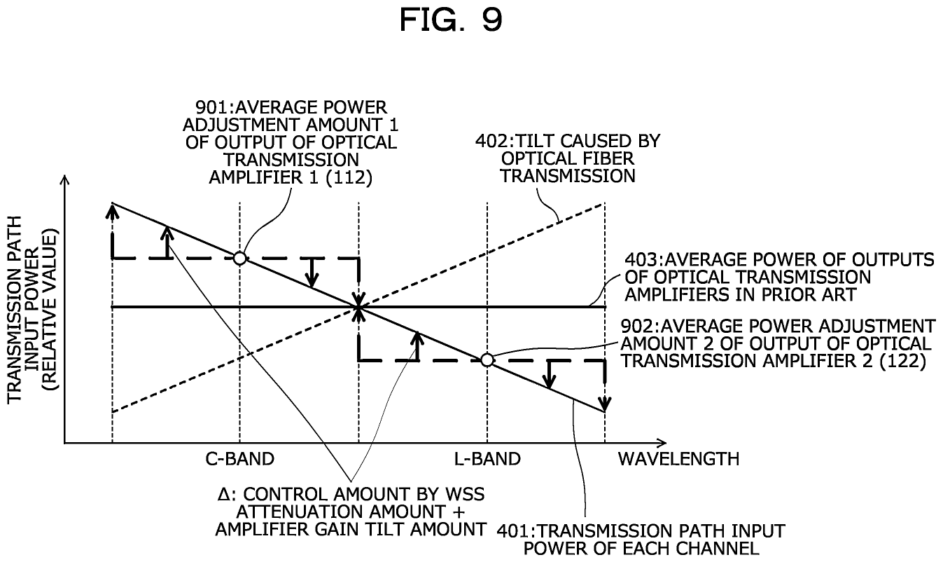

FIG. 9 is an explanatory diagram of the attenuation amount control and the amplifier gain tilt amount control according to the embodiment. Similarly to the description with reference to FIG. 4, the reference sign 401 (solid line) denotes the transmission path input power (control target value) of each channel for making the GSNRs of C+L equalized. Furthermore, the reference sign 402 (dotted line) denotes the tilt caused by the optical fiber transmission of the transmission path 330. The reference sign 403 (bold line) denotes the average power of the outputs of the optical transmission amplifiers 1 and 2 (312, 322) described in the prior art.

In the optical transmission device 100 of the embodiment, the VOAs 113 and 123 for the respective bands are arranged at the post-stages of the optical transmission amplifiers 1 and 2 (112, 122). The VOA 113 of the C-band sets an average power adjustment amount 1 (reference sign 901) of the output of the optical transmission amplifier 1 (112), and the VOA 123 of the L-band sets an average power adjustment amount 2 (reference sign 902) of the output of the optical transmission amplifier 2 (122). For example, the average power adjustment amount 1 (901) is set to a center wavelength of the C-band, and the average power adjustment amount 2 (902) is set to a center wavelength of the L-band. The average power adjustment amounts 1 and 2 correspond to the optical attenuation amounts of the VOAs 113 and 123.

Here, the prior art in FIG. 4 and the embodiment in FIG. 9 will be compared. The prior art in FIG. 4 and the embodiment in FIG. 9 are different in that, in the prior art in FIG. 4, the one average power 403 of the optical amplifier outputs is set for all the bands, whereas in the embodiment in FIG. 9, the average power 901 and 902 of the two optical amplifier outputs are set for the respective bands.

In the embodiment, by setting the average power adjustment amounts 1 and 2 (901, 902) for the respective bands, a control amount Δ by the WSS attenuation amount+the amplifier gain tilt amount may be made smaller than that of the prior art (FIG. 4). For example, since a WSS control amount may be reduced, input optical power to the optical transmission amplifiers 1 and 2 (112, 122) is increased, and the OSNR higher than that in the prior art is implemented, so that the transmission characteristics are improved.

For example, the control unit 103 determines the transmission path input power of each channel such that the GSNRs are equalized (the transmission characteristics are maximized). The power of each channel controls “the WSS attenuation amount+the amplifier gain tilt amount” based on monitor values of the OCMs 1 and 2 (163, 173) and the PDs 1 to 4 (114, 124, 161, 171). Furthermore, the control unit 103 performs the control according to “the average power adjustment amounts 1 and 2 (VOA attenuation amounts) of the outputs of the two optical transmission amplifiers 1 and 2 (112, 122)” stored in the DB 104 in advance. The average power adjustment amounts 1 and 2 stored in the DB 104 may be calculated based on characteristics of each optical amplifier measured in advance and transmission path conditions of the transmission path 130.

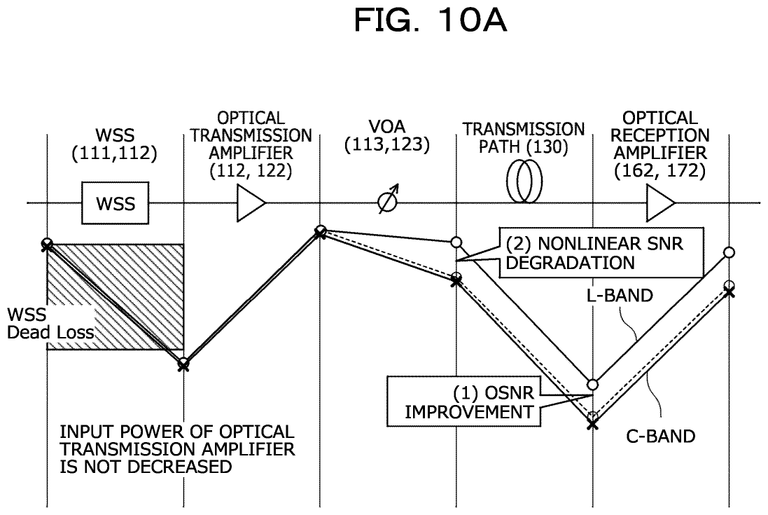

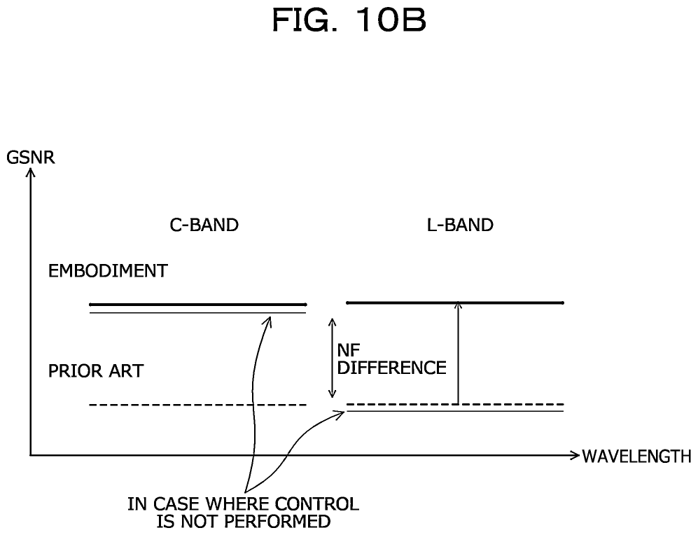

FIG. 10A is a level diagram in a case where the GSNR equalization is performed according to the embodiment. FIG. 10B is a diagram illustrating the GSNR for each band at the time of the GSNR equalization according to the embodiment. As illustrated in FIG. 10A, in the embodiment, in order to obtain an expected level of the transmission path input power, the attenuation amount is individually controlled by the VOAs 113 and 123 of the C-band and the L-band, and a deviation is given to the output power (transmission path input power) for each band. In the example of FIG. 10A, the attenuation amount of the C-band is set greater than that of the L-band in terms of the output power of the VOAs 113 and 123.

As a result, the input power to the optical transmission amplifier 312 of the C-band of the prior art (FIG. 7A) decreases, whereas in the embodiment (FIG. 10A), a decrease in the input power to the optical transmission amplifier 112 of the C-band may be avoided, and a decrease in the OSNR may be suppressed.

Furthermore, as illustrated in FIG. 10B, in the embodiment, the transmission path input power of the L-band is set high so as to eliminate an NF difference. In FIG. 10B, in a case where the GSNR control itself is not performed (solid lines), a difference is generated in the GSNR according to the NF difference between the C/L bands. Furthermore, according to the prior art (dotted lines), although the GSNRs are made equalized, the input power to the optical transmission amplifier decreases, so that the GSNR as an absolute value is low. On the other hand, in the embodiment (bold lines), in a balance between 1. OSNR improvement and 2. nonlinear SNR degradation, the OSNR improvement may be made greater than the nonlinear SNR degradation, so that the GSNR may be improved.

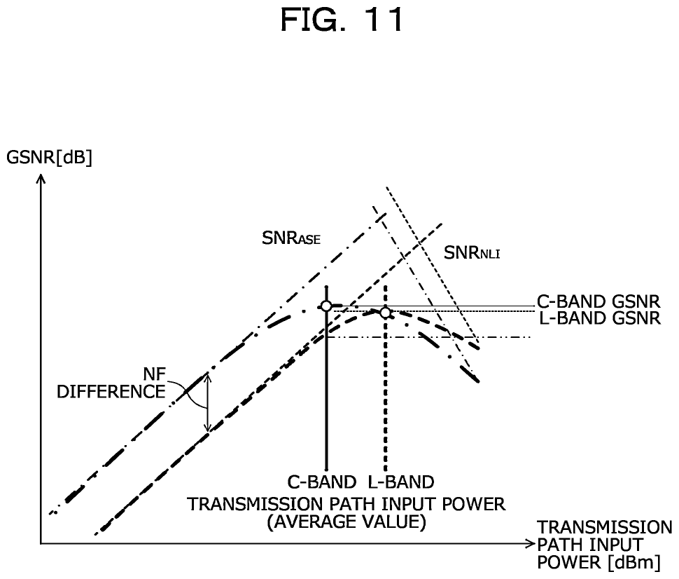

FIG. 11 is a diagram illustrating the GSNR for each band at the time of the GSNR equalization according to the embodiment. In the embodiment, the output levels are controlled for the respective bands by the VOAs 113 and 123 arranged at the post-stages of the optical transmission amplifiers 1 and 2 (112, 122), and the output level of the L-band is increased as illustrated in FIG. 11, thereby improving the GNSR of the L-band and eliminating the difference in the GSNR. In comparison between FIG. 8 and FIG. 11, in the transmission path input power (average value) of the L-band, the GSNR is set at a higher position.

Based on Expression (1) described above, SNR_{ASE}=optical transmission amplifiers 1 and 2 input power (AmpInPower)−NF+constant . . . (2) is indicated. Here, since the NF of the L-band is greater than that of the C-band, the SNR_{ASE} is reduced by increasing the output level of the L-band. Furthermore, a nonlinear SNR of the L-band whose wavelength is away from a zero dispersion wavelength of an optical fiber increases (nonlinear noise is small).

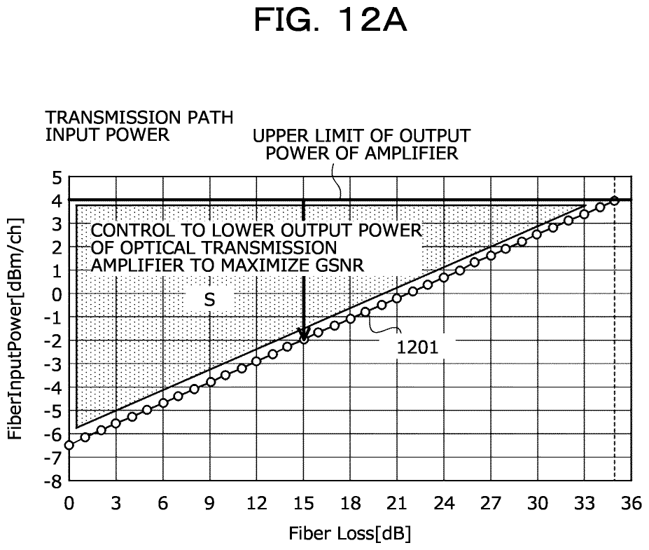

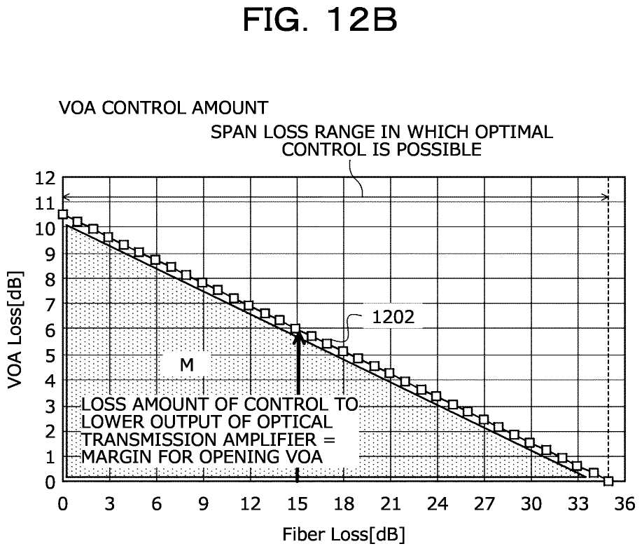

FIG. 12A is an explanatory diagram of the transmission path input power in the embodiment. FIG. 12B is an explanatory diagram of a VOA control amount in the embodiment. A horizontal axis of each of these drawings represents a span loss of the transmission path 130 (a fiber loss of the transmission path 130), a vertical axis of FIG. 12A represents the transmission path input power, and a vertical axis of FIG. 12B represents a VOA loss.

In the embodiment, as described above, as a result of optimizing the transmission path input power in order to maximize the GSNR, control is performed to lower the output power of the optical transmission amplifiers 1 and 2 (112, 122) according to the span loss of the transmission path 130 (in proportion to a dB value). In the example of FIG. 12A, output power characteristics 1201 of the optical transmission amplifiers 1 and 2 (112, 122) are increased in proportion to an increase in the span loss (for example, 0 to 35 dB). The control unit 103 sets an upper limit of the output power of the optical transmission amplifiers 1 and 2 (112, 122) to the maximum span loss (35 dB), and performs control to lower the output power characteristic 1201 within a region S between the output power characteristics 1201 and the upper limit of the output power of the amplifiers as the span loss is smaller.

Then, in the embodiment, the control unit 103 performs the attenuation amount control by control of the VOAs 113 and 123 in addition to the optical transmission amplifiers 1 and 2 (112, 122). As illustrated in FIG. 12A, since there is the upper limit to the output power of the optical transmission amplifiers 1 and 2 (112, 122), the output power may not be set to an optimal point at a certain span loss or more.

Thus, as illustrated in FIG. 12B, the control unit 103 performs, for attenuation amount characteristics 1202 of the VOAs 113 and 123, control to open the VOAs (reduce the attenuation amounts) in a margin region M as the span loss is greater, corresponding to the span loss (0 to 35 dB) range in which optimal control is possible.

For example, in a case where the span loss is 15 dB, the control unit 103 controls the output levels of the optical transmission amplifiers 1 and 2 so that the transmission path input power is −2 dB (FIG. 12A), and controls the opening (attenuation amounts) of the VOAs to be 6 dB. Note that the control amounts illustrated in FIGS. 12A and 12B have individual settings for each of the C-band and the L-band, and the control unit 103 performs individual control for the respective bands with reference to the settings of the C-band and the L-band.

As described above, in the embodiment, the attenuation amount control by the VOAs 113 and 123 is performed in the span loss (0 to 35 dB) range in which the optimal control is possible up to the upper limit output power of the optical transmission amplifiers 1 and 2 (112, 122). The control unit 103 performs control to increase the attenuation amounts of the VOAs 113 and 123 so that the output power of the optical transmission amplifiers 1 and 2 (112, 122) is lowered as the span loss of the transmission path 130 is smaller.

For the output level control for each band, as described above, the control unit 103 performs control to increase the output power of the VOA 123 of the L-band to be higher than the output power of the VOA 113 of the C-band. By increasing the output power of the VOA 123 of the L-band, the GSNR may be improved. The NF of the optical transmission amplifier 112 of the L-band is worse than the NF of the optical transmission amplifier 112 of the C-band, and nonlinear noise is less likely to occur. Thus, the transmission path input power with the best GSNR is higher in the L-band than in the C-band.

Then, in a case where the span loss is small, the GSNR may be improved by an effect that the nonlinear SNR is improved when the output levels are lowered by the VOAs 113 and 123 as compared with the output level adjustment by the optical transmission amplifiers 1 and 2 (112, 122). The margin region M is provided in which, the smaller the span loss, the more the VOAs 113 and 123 are opened by causing operation of closing (attenuating) the VOAs to be performed.

The values (the output power characteristics 1201 and the attenuation amount characteristics 1202) of the different output levels according to the span loss illustrated in FIGS. 12A and 12B are held in the DB 104 as the control target values for the respective bands (equivalent to the control target values of the transmission path input power), and the control unit 103 performs control with reference to the values.

### Hardware Configuration Example of Control Unit

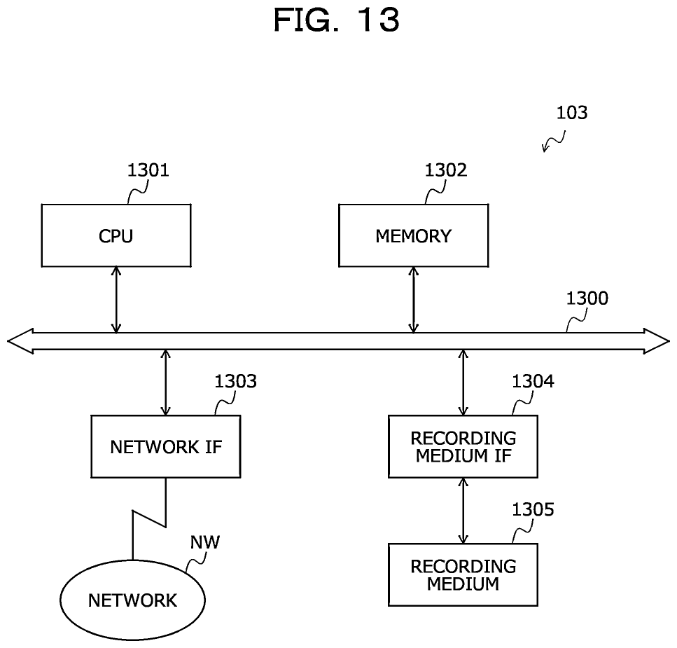

FIG. 13 is a diagram illustrating a hardware configuration example of the control unit of the optical transmission device. The control unit 103 of the optical transmission device (node A) 100 illustrated in FIG. 1 may be configured by, for example, hardware illustrated in FIG. 13.

For example, the control unit 103 includes a processor 1301 such as a central processing unit (CPU), a memory 1302, a network interface (IF) 1303, a recording medium IF 1304, and a recording medium 1305. Furthermore, the respective components are coupled to each other by a bus 1300.

Here, the processor 1301 is a control unit that performs control of the entire control unit 103. The processor 1301 may include a plurality of cores. The memory 1302 includes, for example, a read only memory (ROM), a random access memory (RAM), a flash ROM, and the like. For example, the flash ROM stores a control program, the ROM stores an application program, and the RAM is used as a work area for the processor 1301. The program stored in the memory 1302 causes the processor 1301 to execute coded processing by being loaded into the processor 1301.

The network IF 1303 manages an interface between a network NW and the inside of the device, and controls input and output of information with respect to the outside of the device.

The recording medium IF 1304 controls reading/writing of data from/to the recording medium 1305 under the control of the processor 1301. The recording medium 1305 stores data written under the control of the recording medium IF 1304.

Note that the control unit 103 may be coupled to, for example, an input device, a display, or the like via an IF, in addition to the components described above.

The processor 1301 illustrated in FIG. 13 may implement the function of the control unit 103 illustrated in FIG. 1 by execution of the program. Furthermore, the function of the storage unit (DB) 104 illustrated in FIG. 1 may be implemented by using the memory 1302 and the recording medium 1305 illustrated in FIG. 13.

A function of a control unit (not illustrated) of the node B illustrated in FIG. 1 may also be implemented by using the hardware configuration illustrated in FIG. 13.

### Control Processing Example of Control Unit

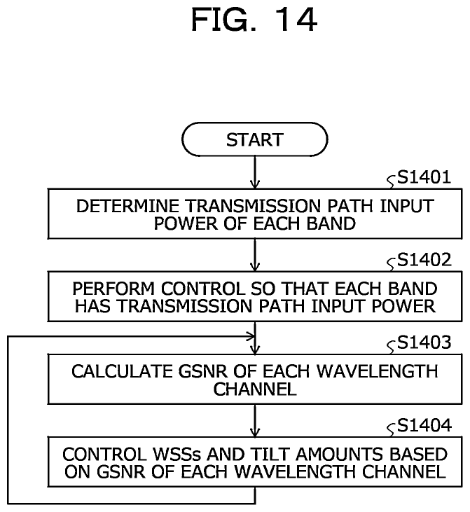

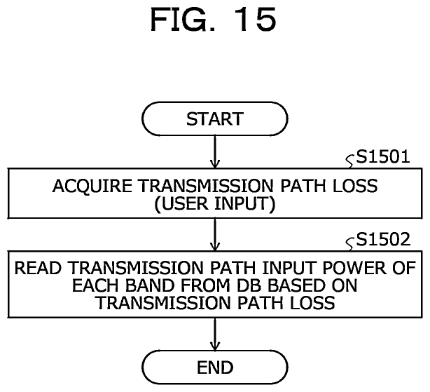

FIGS. 14 and 15 are flowcharts illustrating a control processing example of the control unit. FIG. 14 illustrates overall control processing by the control unit 103, which is executed and processed by the processor 1301 illustrated in FIG. 13. As illustrated in FIG. 14, first, the control unit 103 determines transmission path input power of each band (C, L) (operation S1401). Although this determination processing will be described with reference to FIG. 15, the control unit 103 makes the determination based on, for example, values stored in advance in the DB 104.

Next, the control unit 103 performs control so that each band has the determined transmission path input power (operation S1402). Next, the control unit 103 calculates a GSNR of each wavelength channel (operation S1403).

Then, the control unit 103 controls attenuation amounts by the WSSs 1 and 2 (111, 121) and tilt amounts of the optical transmission amplifiers 1 and 2 (111, 121) of the respective bands based on the GSNR of each wavelength channel (operation S1404). After the processing of operation S1404, the control unit 103 returns to the processing of operation S1403 and continues the processing of operations S1403 and S1404 during operation. The processing of operations S1403 and S1404 is processing corresponding to the prior art (U.S. Patent Application Publication No. 2022/0368448).

FIG. 15 is a processing example of determining the transmission path input power of each band illustrated in operation S1401 of FIG. 14. For example, the control unit 103 acquires a transmission path loss (a span loss of a transmission path 150) by a user input (operation S1501). Based not only on the user input but also on monitor values of the PDs 1 and 2 (114, 124) and the PDs 3 and 4 (161, 171), the control unit 103 may calculate the transmission path loss and store the transmission path loss in the DB 104.

Next, the control unit 103 reads the transmission path input power of each band (C, L) from the DB 104 based on the transmission path loss (operation S1502), and ends the above processing. The control unit 103 proceeds to the processing of operation S1402 of FIG. 14 based on the read transmission path input power (output power of the post-stage amplifiers 112c and 122c) of each band (C, L).

The optical transmission device according to the embodiment described above includes optical transmission amplifiers for the respective bands, each of which optically amplifies signal light of the band of a different wavelength band with respect to the transmission path. Furthermore, output level adjustment units each of which is arranged at a post-stage of the optical transmission amplifier for each band, adjusts an output of the optical transmission amplifier for each band, and outputs the adjusted output to the transmission path is included. For example, the VOAs may be used as the output level adjustment units. The control unit performs control on the output level adjustment units for the respective bands so as to reduce a difference in the GSNR between the bands. For example, the control unit performs control to make the GSNRs equalized on the output level adjustment units for the respective bands based on the difference in the GSNR between the bands. As a result, it is possible to eliminate the difference in the GSNR between the respective bands of the multi-band transmission and improve the transmission characteristics.

Furthermore, in the optical transmission device of the embodiment, the bands may be applied to the C-band and the L-band. In this case, based on noise figures of the optical transmission amplifiers and nonlinear noise for the respective bands, the control unit may perform control on the output level adjustment unit of the L-band so as to make the output level of the L-band higher than that of the C-band. As a result, it is possible to eliminate the difference in the GSNR caused by an NF difference and the nonlinear noise for the respective bands, and it is possible to improve the transmission characteristics in the multi-band transmission of the C+L bands.

Furthermore, in the optical transmission device of the embodiment, the control unit may calculate average output levels of the optical transmission amplifiers different for the respective bands based on characteristics of the optical transmission amplifiers and conditions of the transmission path, and determine control amounts for equalizing the GSNRs of the respective bands using the average output levels. In the GSNR equalization of the prior art, since one average output level is used, an attenuation control amount of tends to increase, and for example, a decrease in an OSNR occurs due to a decrease in input power to the optical transmission amplifiers. On the other hand, in the embodiment, the attenuation control amount may be suppressed based on the settings of the two average output levels for the respective bands, and the OSNR may be improved by suppressing the decrease in the input power to the optical transmission amplifiers of the respective bands.

Furthermore, the optical transmission device of the embodiment may include the storage unit that holds in advance control target values for the respective bands corresponding to equalization of the GSNRs of the C-band and the L-band at the time of the maximum number of wavelengths of a transmission state. Additionally, the control unit may control the output level adjustment units for the respective bands with reference to the control target values for the respective bands, which are held in the storage unit. As a result, it is possible to easily perform the control of the GSNR equalization of the multi-band transmission.

Furthermore, in the optical transmission device of the embodiment, the storage unit may hold the control target values for the respective bands of the optical transmission amplifiers and the output level adjustment units, which correspond to a span loss of the transmission path. Additionally, the control unit may perform, based on the acquired span loss of the transmission path, control with the control target values corresponding to the span loss, which are held in the storage unit. As a result, it is possible to easily perform the control of the GSNR equalization by adapting to the span loss of the transmission path.

Furthermore, in the optical transmission device of the embodiment, with the control target values for the respective bands of the output level adjustment units, the smaller the span loss of the transmission path, the lower the output level and the optical attenuation is performed. The output level adjustment units optically attenuate the optical power after the optical amplification by the optical transmission amplifiers with the VOAs or the like. In a case where the span loss is small, a nonlinear SNR is improved and the GSNR may be improved by lowering the VOA output level.

Furthermore, in the optical transmission device of the embodiment, the control unit may acquire the span loss of the transmission path by a user input. As a result, it is possible to perform the control of the GSNR equalization corresponding to the span loss input by the user.

Moreover, in the optical transmission device of the embodiment, the own device may include optical power monitors each of which detects the output power of each band. Furthermore, the reception side node may include optical power monitors each of which detects the input power of each band, and the control unit may calculate the span loss of the transmission path based on outputs of the respective optical power monitors. As described above, it is possible to perform the control of the GSNR equalization corresponding to the span loss of the transmission path calculated based on the outputs of the optical power monitors for the respective bands of each of the transmission and reception nodes.

Furthermore, the optical transmission device of the embodiment may include the wavelength selective switches that attenuate the input power of the optical transmission amplifiers for the respective bands. In this case, the control unit further performs optical attenuation control on the wavelength selective switches and amplifier gain tilt amount control on gain tilts of the optical transmission amplifiers for the respective bands. The transmission characteristics in the multi-band transmission may be improved by performing the optical attenuation control on the existing wavelength selective switches and the amplifier gain tilt amount control on the optical transmission amplifiers for the respective bands, and further performing the control on the output level adjustment units according to the embodiment described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmission device comprising:
an optical transmission amplifier for each band configured to optically amplify signal light of the band of a plurality of different wavelength bands;
output level adjuster arranged at a post-stage of the optical transmission amplifier for each band, and configured to adjust an output of the optical transmission amplifier for each band and output the adjusted output to the transmission path;
a memory; and
a processor coupled to the memory and configured to make the output level adjuster for the each band to reduce a difference in a generalized signal to noise ratio (GSNR) between the bands.

2. The optical transmission device according to claim 1, wherein the output level adjuster is a variable optical attenuator.

3. The optical transmission device according to claim 2, wherein the plurality of different wavelength bands are a C-band and an L-band.

4. The optical transmission device according to claim 3, wherein the processor is configured to make an output level of the L-band higher than an output level of the C-band.

5. The optical transmission device according to claim 4, wherein the processor is configured to make the output level to change according to a span loss of the transmission path.

6. The optical transmission device according to claim 5, wherein the processor is configured to make the output level to reduce as the span loss decreases.

7. The optical transmission device according to claim 6,
wherein target values of output levels of the C-band and the L-band are stored in the memory in advance, and
wherein the processor is configured to make the output levels to become to the target values.

8. The optical transmission device according to claim 7, wherein one of the target values and a target value of a difference between the output levels is a value according to the span loss.

9. An optical transmission device comprising:
an optical transmission amplifier configured to optically amplify signal light of a band of different wavelength bands;
an output level adjuster arranged at a post-stage of the optical transmission amplifier for each band, and configured to adjust an output level of the optical transmission amplifier for each band and output the signal light of the adjusted output level to the transmission path;
a memory; and
a processor coupled to the memory and configured to make an output level adjuster for the each band to equalize a generalized signal to noise ratio (GSNR), based on a difference in generalized signal to noise ratios (GSNRs) generated between the outputs of the optical transmission amplifier for the each band.

10. The optical transmission device according to claim 9,
wherein the each band includes one of a C-band and an L-band, and
wherein the processor is configured to make the output level adjuster of the L-band higher than an output level of the C-band, based on a noise figure of the optical transmission amplifier and a nonlinear noise for the each band.

11. The optical transmission device according to claim 9,
wherein the processor is configured to:
calculate an average output level of the optical transmission amplifier different for the each band, based on the noise figure of the optical transmission amplifier and a nonlinear noise of the transmission path, and
determine a control target value to equalize the GSNR of the each band by using the average output level.

12. The optical transmission device according to claim 10,
wherein a control target value for the each band is held in the memory in advance, the control target value corresponding to equalization of the GSNRs of the C-band and the L-band at a time of a transmission state of a maximum number of wavelengths, and
wherein the processor is configured to make the output level adjuster for the each band to adjust the output level, with reference to the control target value for the each band, which is held in the memory.

13. The optical transmission device according to claim 12,
wherein the control target values for the each band of the optical transmission amplifier and the output level adjuster are held in the memory, the control target value corresponding to a span loss of the transmission path, and
wherein the processor is configured to make, based on the span loss, the output level adjuster to adjust the output level, with the control target value corresponding to the span loss, which is held in the memory.

14. The optical transmission device according to claim 13, wherein, the control target value for the each band of the output level adjuster causes the smaller the span loss of the transmission path, the lower the output level and optical attenuation.

15. The optical transmission device according to claim 13, wherein the processor is configured to acquire the span loss of the transmission path by a user input.

16. The optical transmission device according to claim 13, further comprising:
an optical power monitor configured to detect output power of each band, the optical power monitor that detects input power of each band being included in a reception side node,
wherein the processor is configured to acquire the span loss of the transmission path, based on the detected output power of the optical power monitor.

17. The optical transmission device according to claim 9, further comprising:
a wavelength selective switch configured to attenuate input power of the optical transmission amplifier for each band,
wherein the processor is configured to make the wavelength selective switch to attenuate the input power, and to control an amplifier gain tilt amount for a gain tilt of the optical transmission amplifier for each band.

18. An transmission optical power control method of an optical transmission device including an optical transmission amplifier to optically amplify optical signal light of a band of a plurality of different wavelength bands, an output level adjuster to adjust an output of the optical transmission amplifier for each band and output the adjusted output to the transmission path, and a processor, the transmission optical power control method comprising:
making the output level adjuster for the each band to reduce a difference in a generalized signal to noise ratio (GSNR) between the bands, by the processor.
